(19) United States
(12) Patent Application Publication
(10) Pub. No.: US 2007/0242039 A1
(43) Pub. Date: Oct. 18, 2007

(54) Pointing device with security capabilities

(76) Inventors: Mike Chen, Arcadia, CA (US); Fuliang Cho, San Jose, CA (US); Futong Cho, Milpitas, CA (US); Liang Seng Koh, Fremont, CA (US); Hsin Pan, Fremont, CA (US)

Correspondence Address: SILICON VALLEY PATENT AGENCY, 7394 WILDFLOWER WAY, CUPERTINO, CA, 95014, US

(21) Appl. No.: 11/379,049

(22) Filed: Apr. 17, 2006

(51) Int. Cl. G09G 5/08

(52) U.S. Cl. 345/157

(57) ABSTRACT

Pointing device providing security means are disclosed. A pointing device is designed to be able to read or write various cards (e.g., tags, IC or magnetic cards, etc.) and communicate securely with a host device. In one embodiment, the pointing device includes a card detector that communicates with a card, and a security engine configured to automatically establish a secured communication channel with a host device when a software module is activated in the host device such that data exchanged between the card and the host device is secured.

### BACKGROUND

1. Technical Field

The present invention is generally related to pointing devices such as a mouse for computer devices. Particularly, the present invention is related to pointing devices capable of reading or writing various cards (e.g., tags, ID or magnetic cards, etc.) and communicating securely with a host device.

2. Description of the Related Art

A mouse is a small device that a computer user moves across a desk surface in order to point to a place on a display screen and to select one or more actions to take from that position. The mouse first became a widely-used computer tool when Apple Computer made it a standard part of the Apple Macintosh. Today, the mouse is an integral part of the graphical user interface (GUI) of any personal computer.

At the same time, a personal computer is becoming an auxiliary for an enterprise or a necessary personal device. People rely on personal computers to communicate with others through the Internet. On the consumer side, many use their personal computers to purchase goods or services electronically over the Internet. One of the issues in such transactions over the Internet is the payment, namely how a user pays from his/her own account to an account maintained by a merchant in a financial institution that is often remotely separated from the merchant.

Techniques are needed to provide secure communication from a pointing device through an application server to conduct a financial transaction electronically over a network.

### SUMMARY

This section is for the purpose of summarizing some aspects of embodiments of the present invention and to briefly introduce some preferred embodiments. Simplifications or omissions in this section as well as the title and the abstract of this disclosure may be made to avoid obscuring the purpose of the section, the title and the abstract. Such simplifications or omissions are not intended to limit the scope of the present invention.

Broadly speaking, the invention is related to a pointing device (e.g., a computer mouse) that is capable of reading or writing carious cards (e.g., tags, IC or magnetic cards, etc.) and communicating securely with a host device. According to one aspect of the present invention, a card detector is provided in a pointing device and configured to communicate with a card including at least monetary information; and a security engine configured to automatically establish a secured communication channel with a host device when a software module is activated in the host device such that data exchanged between the card and the host device is secured.

The invention may be implemented in numerous ways, including a method, system, and device. In one embodiment, the present invention is a pointing device comprising a card detector configured to communicate with a card including at least monetary information; and a security engine configured to automatically establish a secured communication channel with a host device when a software module is activated in the host device such that data exchanged between the card and the host device is secured, wherein the host device is configured to enable a user to place an order on a merchant website over a network, the website merchant causes the host device to communicate with a website operated by a financial institution, which requires the card be scanned so that stored data is transported securally to the financial website via the appointing device as well as the host device.

Accordingly one of the objects of the present inventions is to provide pointing devices capable of reading or writing various cards and communicating securely with a host device.

Other objects, features, and advantages of the present invention will become apparent upon examining the following detailed description of an embodiment thereof, taken in conjunction with the attached drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows an exemplary pointing device (i.e., a mouse) integrated with card-reading capability that can read or write a card;

FIG. 2 shows an exemplary block diagram of a pointing device in accordance with one embodiment of the present invention;

FIG. 3A shows a configuration in which the present invention may be practiced; and

FIG. 3B shows an example of a receipt.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments do not inherently indicate any particular order nor imply limitations in the invention.

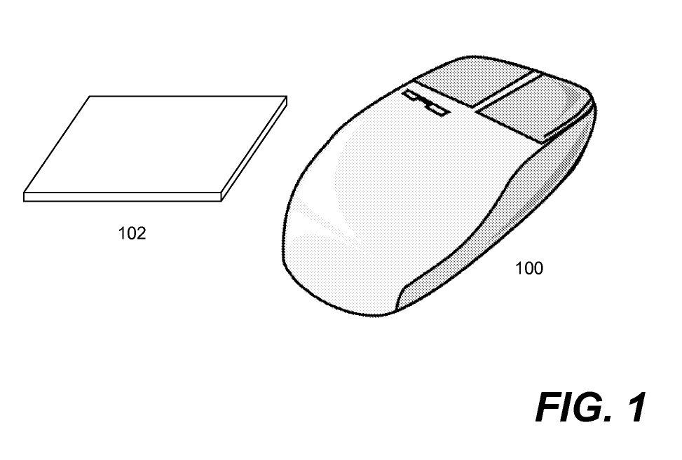

Embodiments of the present invention are discussed herein with reference to FIGS. 1-3B. However, those skilled in the art will readily appreciate that the detailed description given herein with respect to these figures is for explanatory purposes only as the invention extends beyond these limited embodiments.

FIG. 1 shows an exemplary pointing device (i.e., a mouse) 100 integrated with card-reading capability that can read or write a card 102. In one embodiment, the mouse 100 is made to include a slot to receive the card 102 so that the card 102 can be read and wrote. In another embodiment, the mouse 100 is made to include a transponder that reads and writes the card 102 wirelessly. An example of the card 102 may include, but not be limited to, an IC card, a card with magnetic strips, a memory card, a driving control card, and an identification card. It should be noted, unless specifically stated, that a card as used herein is not limited to a card shape. In fact, it is understood to those skilled in the art that any form of a device including an IC chip and a transponder may interact wirelessly with the mouse 100. In one deployment, as will be further described below, the card 102 is presented to the pointing device 100 after a user is ready to pay for an order placed online or check in for admission. It is assumed that the card 102 possesses a certain monetary function so that the cost for the order or admission may be deducted from the card.

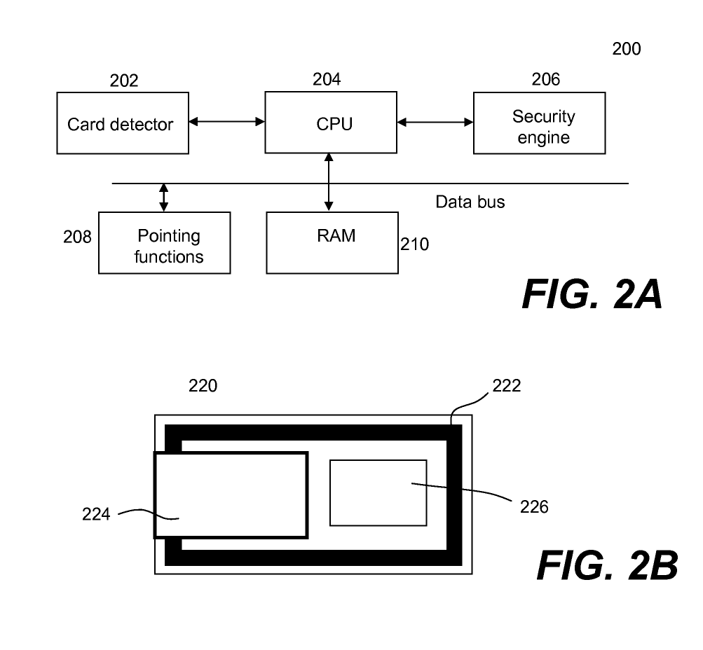

Referring now to FIG. 2, there shows an exemplary block diagram of a pointing device 200 in accordance with one embodiment of the present invention. The pointing device 200 includes a card detector 202, a CPU 204, a security engine 206 and a RAM 210. The original functions of a regular point device are represented collectively in a function block 208. Depending on implementation, the card detector 202 may be coupled to a slot that is provided to receive a card for contact communication, or include a transponder to communicate with a card without contact. Stored data in the card is read in by the CPU 204 and transported to a host device in a secured channel established by the security engine 206 and a counterpart in the host device. In other words, any data exchanged between the card and the host device via the pointing device 200 is secured. The RAM 210 is provided to store code, for example, for the security engine 206.

FIG. 2B shows an exemplary implementation of a card detector 220. As shown in the figure, the card detector 220 includes an antenna strip 222 to communicate with a card wirelessly by radio frequency (RF), and at the same time, includes a slot 224 to receive a card to engage for communication with contact. Circuitry 226 is provided to read data from the card regardless of how the card is communicated with.

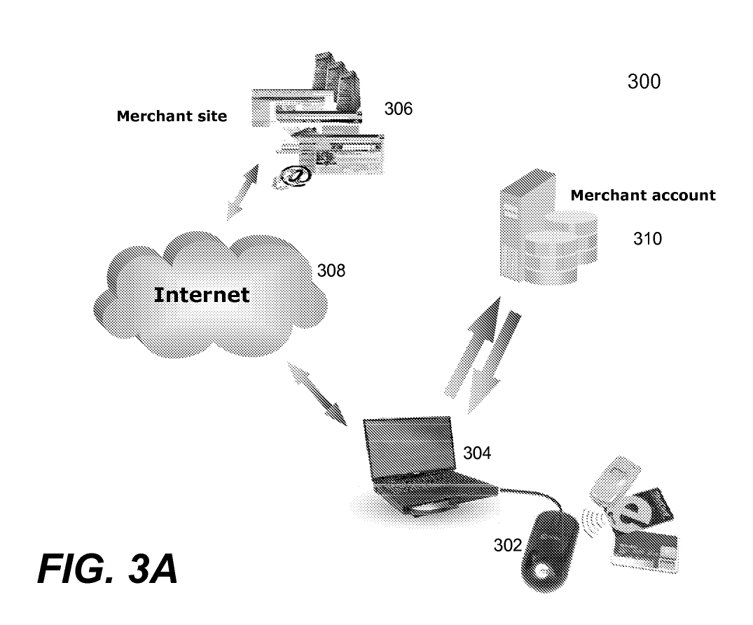

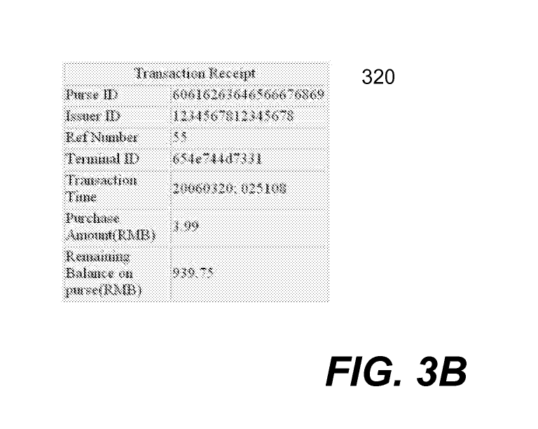

Referring now to FIG. 3A, there shows a configuration 300 in which the present invention may be practiced. A pointing device 302 as contemplated in accordance with the present invention is coupled to a personal computer 304. As described above, the pointing device 302 is designed to be able to exchange data with a card (e.g., a RF IC card or a magnetic-strip card). As some portable devices are equipped with a transponder, such as a cell phone, the pointing device 302 is in one embodiment designed to be able to communicate wirelessly with such a portable device.

In operation, the pointing device 302 works as a regular pointing device and allows a user to move around a screen 302 for selected action. The personal computer 304 is coupled to a merchant site 306 via the Internet 308 so that the user is able to select a type of service or goods. After an order is placed, the merchant site 306 redirects the personal computer 304 to a financial website 310 operated by a financial institution maintaining an account. At this time, the user may be required to scan a card or a portable device via the pointing device 302.

Stored data in the card or the portable device is read out by the pointing device 302. A secure communication channel is established between the pointing device 302 and the personal computer 304. A software module executed in the personal computer 304 determines whether there is a sufficient balance to place an order of the selected server or goods. If it is determined that there is a sufficient balance, the software module is configured to communicate with the site 310 that proceeds with verification of the data sent from the software module. If the verification succeeds, the order placed by the user is accepted by the merchant site 306 and at the same time the amount for the order is deducted from the card or portable device.

In operation, after the verification, the personal computer 304 receives a message from the financial website 310. The message indicates how much to be deducted from the card or portable device. The software module executed in the personal computer 304 produces data reflecting a balance and writes the new balance into the card or portable device via the pointing device 302. In one embodiment, a receipt is displayed on a display of the personal computer 304.

FIG. 3B shows an example of such a receipt 320 that includes a purse ID, an issuer ID, a RefNumber 55, a terminal ID, a transaction time, a purchase amount, and a remaining balance on purse. The purse ID pertains to the card for authorization. The issuer ID is related to a financial institution that issues the card or manages an account associated with the card. The RefNumber is used to reference a transaction. The transaction records when the transaction happens. The purchase amount indicates how much the user has agreed to pay for his/her order. The remaining balance is what the card can be still used without recharging.

To recharge a card, in one embodiment, a user uses his/her portable device to move a certain amount from his/her account at a bank to the card. It is assumed that the portable device has an imbedded transponder or slot reader that transmits an authorized amount to the card so that the balance in the card is updated. In one embodiment, the pointing device is used to verify or read out the balance in a card, in which case, the host device does not have to be online. The pointing device may also be used to read out account information and/or transactions history.

According to embodiment, a pointing device contemplated in accordance with the present invention is used together with a host computer in an enclosed environment. The pointing device is used to conduct secured transactions between a card owner and an operator of the host device. Typically, the host device is loaded with at least a secure module that is configured to cause the pointing device to read out certain information from the card and write back updated or new information to the card to conduct a transaction.

Now referring back to FIGS. 2A and 2B, the pointing device acts as a reading and writing terminal to enable a user to interact with the electronic purse/wallet throughout each electronic payment operation. The user may need to communicate with the backend payment server to retrieve information needed for instructing the selected purse to perform the operation. This operation can either be transactional such as purchase and load, or non-transactional such as balance enquiry. As described above, the pointing device capable of securing a communication between itself and a payment client extends security from payment client to the payment terminal. This channel provides access key protection for weaker security contactless transponders such as those based on ISO 14443 standard.

Coupling with networked backend hardware security modules, the pointing device acts as a virtual secured access module (SAM) to each terminal of a payment system based on weaker security contactless transponders. With this virtual SAM, keys are generated at the backend and delivered to the terminals. No physical hardware SAM is installed at each terminal. This enables a payment system based on these transponders to be deployed and operated in an open environment such as the internet.

The foregoing description of embodiments is illustrative of various aspects/embodiments of the present invention. Various modifications to the present invention can be made to the preferred embodiments by those skilled in the art without departing from the true spirit and scope of the invention as defined by the appended claims. Accordingly, the scope of the present invention is defined by the appended claims rather than the foregoing description of embodiments.

We claim:

1. A pointing device comprising:
a card detector configured to communicate with a card including at least monetary information; and
a security engine configured to automatically establish a secured communication channel with a host device when a software module is activated in the host device such that data exchanged between the card and the host device is secured.

2. The pointing device as recited in claim 1 further comprising:
memory for storing code to support the security engine; and
a CPU configured to execute the code to facilitate the security engine to establish the secured communication channel with the host device.

3. The pointing device as recited in claim 1, wherein the card detector includes a transponder that facilitates wireless communication between the card and the pointing device.

4. The pointing device as recited in claim 1, wherein the card detector includes a card slot to physically receive the card, and facilitates communication between the card and the pointing device.

5. The pointing device as recited in claim 1, wherein the card detector is configured to communicate with the card either with contact or without contact.

6. The pointing device as recited in claim 5, wherein the card detector includes both a transponder that facilitate wireless communication between the card and a card slot to physically receive the card, and facilitates communication between the card and the pointing device.

7. The pointing device as recited in claim 1, wherein the host device is used to read out a balance in the card via the pointing device.

8. The pointing device as recited in claim 7, wherein the card is recharged via a transponder in a portable device that is used to communicate with an institution issuing or managing the card.

9. The pointing device as recited in claim 7, wherein, in providing regular pointing functions as seen in a computer mouse, the pointing device acts as a reading and writing terminal to enable a user to interact with an electronic purse/wallet throughout each electronic payment operation.

10. A pointing device comprising:
a card detector configured to communicate with a card including at least monetary information; and
a security engine configured to automatically establish a secured communication channel with a host device when a software module is activated in the host device such that data exchanged between the card and the host device is secured,
wherein the host device is configured to enable a user to place an order on a merchant website over a network, the website merchant causes the host device to communicate with a website operated by a financial institution, which requires the card be scanned so that stored data is transported securally to the financial website via the appointing device as well as the host device.

11. The pointing device as recited in claim 10 further comprising:
memory for storing code to support the security engine; and
a CPU configured to execute the code to facilitate the security engine to establish the secured communication channel with the host device.

12. The pointing device as recited in claim 10, wherein the card detector includes a transponder that facilitates wireless communication between the card and the pointing device.

13. The pointing device as recited in claim 10, wherein the card detector includes a card slot to physically receive the card, and facilitates communication between the card and the pointing device.

14. The pointing device as recited in claim 10, wherein the card detector is configured to communicate with the card either with contact or without contact.

15. The pointing device as recited in claim 14, wherein the card detector includes both a transponder that facilitate wireless communication between the card and a card slot to physically receive the card, and facilitates communication between the card and the pointing device.

16. The pointing device as recited in claim 10, wherein the host device is used to verify a balance in the card via the pointing device.

17. A pointing device comprising:
a card detector configured to communicate with a card;
a security engine configured to automatically establish a secured communication channel with a host device when a software module is activated in the host device such that data exchanged between the card and the host device is secured,
wherein the host device is configured to enable a user to present the card to the pointing device, certain information read off the card is transported through the secured communication channel to the host device that returns updated information to be wrote back into the card.

18. The pointing device as recited in claim 17, further including:
memory for storing code to support the security engine; and
a CPU configured to execute the code to facilitate the security engine to establish the secured communication channel with the host device.

19. The pointing device as recited in claim 18, wherein the card detector includes a transponder that facilitates wireless communication between the card and the pointing device.

20. The pointing device as recited in claim 17, wherein the card comes in all types of form and interacts with the pointing device via a transponder embedded in the card.
